(19) United States
(12) Patent Application Publication
(10) Pub. No.: US 2026/0163222 A1
(43) Pub. Date: Jun. 11, 2026

(54) COUPLING BIASING DEVICE AND POWER ADJUSTMENT METHOD FOR COMMUNICATION CIRCUIT

(71) Applicants: NATIONAL CHUNG SHAN INSTITUTE OF SCIENCE AND TECHNOLOGY, Taoyuan City (TW); National Institutes of Applied Research, Taipei City (TW)

(72) Inventors: Yu-shao Shiao, Taipei City (TW); Guo-Wei Huang, Taipei City (TW)

(73) Assignees: NATIONAL CHUNG SHAN INSTITUTE OF SCIENCE AND TECHNOLOGY, Taoyuan City (TW); National Institutes of Applied Research, Taipei City (TW)

(21) Appl. No.: 19/403,038

(22) Filed: Nov. 27, 2025

(30) Foreign Application Priority Data
Dec. 5, 2024 (TW) 113147213

(51) Int. Cl. H01P 5/00

(52) U.S. Cl. CPC H01P 5/00

(57) ABSTRACT

The present disclosure provides a coupling biasing device, which is a biasing device structure for a communication circuit. The coupling biasing device includes a body having a first surface, a second surface, and a through hole, a first wire arranged on the first surface in a fixed shape, and a second wire arranged in the through hole, where the second wire is electrically connected to the communication circuit, and is electrically connected to an external power supply through the first wire, so that the coupling biasing device and the communication circuit are coupled, thereby achieving a purpose of adjusting a communication bandwidth of the communication circuit.

### CROSS-REFERENCE TO RELATED APPLICATION

This non-provisional application claims priority under 35 U.S.C. § 119(a) on Patent Application No(s). 113147213 filed in Taiwan, R.O.C. on Dec. 5, 2024, the entire contents of which are hereby incorporated by reference.

### BACKGROUND OF THE INVENTION

### 1. Field of the Invention

The present disclosure relates to a biasing device structure, and more specifically, to a coupling biasing device for power adjustment of a communication circuit.

### 2. Description of the Related Art

With the progress of science and technology bringing a lot of convenience to human life, various communication technologies have been launched one after another from voice communication of 1G (First Generation) to digital communication of 2G (Second Generation) and to 3G (Third Generation) and B3G (Beyond Third Generation), and now to 4G (Fourth Generation) and 5G (5 th Generation). However, with the development of communication in recent years, in these communication circuits, an active circuit such as a power amplifier or an antenna switch module and a passive circuit such as a filter and a duplexer are usually added to each of the communication circuits, to simultaneously meet requirements for receiving communication data and outputting a radio frequency signal. However, to meet operating bands of different communication systems, the complexity of the communication circuit is increased, resulting in a huge structure of the communication circuit.

Refer to FIG. 1, which is a schematic structural diagram of a conventional broadband biasing device. As shown in the figure, the structure is a series connection of a plurality of inductors 11 with different oscillation frequencies. Through a characteristic that each inductor 11 has a different oscillation frequency, during the modulation of operation of the communication circuit 12, an oscillation frequency generated between the communication circuits 12 is used to improve a bandwidth available for the communication circuit 12. However, through such an arrangement manner, due to a low oscillation frequency generated by each inductor 11, a range of an available bandwidth that can be improved is limited, resulting in poor quality of use.

Refer to FIG. 2, which is a schematic structural diagram of a conventional tapered biasing device. As shown in the figure, the tapered inductor 21 is structurally designed to connect a plurality of inductors 22 in series based on magnitudes of oscillation frequencies to form a tapered inductor 21 with oscillation frequencies arranged from large to small, and then the tapered inductor 21 is electrically connected to a high-frequency signal line 23. Since the bandwidth range covered by the tapered inductor 21 is relatively large, the available bandwidth range also increases accordingly. Therefore, in practical use, the tapered inductor 21 has a higher oscillation frequency than a required bandwidth, and may also operate normally in case of high impedance, which may cause the impedance near a resonant frequency to decrease sharply, resulting in a phenomenon that a field pattern generated by the high-frequency signal line 23 changes and cannot be adjusted. Without changing the design, the inductor may only be used in a band not exceeding the resonant frequency, causing a limited available bandwidth range. In addition, the tapered inductor 21 is composed of a plurality of connected inductors 22 in structural design, resulting in a huge structure of the tapered inductor 21.

### BRIEF SUMMARY OF THE INVENTION

In view of the shortcomings of the foregoing conventional technology, a main purpose of the present disclosure is to provide a coupling biasing device. Through a coupling effect between a first wire and a communication circuit, an oscillation frequency of the communication circuit is changed in a coupling biasing manner, thereby further achieving a purpose of adjusting a communication bandwidth.

To achieve the foregoing purpose, the present disclosure provides a coupling biasing device for use as a biasing device structure in a communication circuit, and the coupling biasing device includes: a body, having a first surface and a second surface, where the first surface is provided with a through hole that runs through the first surface and the second surface; a first wire, arranged on the first surface in a specific shape, where the first wire has a first endpoint and a second endpoint arranged corresponding to the through hole; and a second wire, arranged in the through hole corresponding to the second endpoint, where the second wire is electrically connected to the communication circuit, and the first endpoint is electrically connected to an external power supply, so that the first wire and the communication circuit are coupled, and an oscillation frequency of the communication circuit is changed in a coupling biasing manner, thereby further achieving a purpose of adjusting a communication bandwidth of the communication circuit.

In some embodiments, the body of the coupling biasing device in the present disclosure is a plate.

In some embodiments, the body of the coupling biasing device in the present disclosure is made of one of silicon nitride, gallium nitride, or silicon carbide.

In some embodiments, the first wire of the coupling biasing device in the present disclosure is arranged in a winding manner having the specific shape of an octagon, a circle, or a square.

In some embodiments, the first wire and the second wire of the coupling biasing device in the present disclosure are manufactured by a thin film process.

To achieve the foregoing purpose, the present disclosure further provides a power adjustment method for a communication circuit, which is a method for adjusting a communication bandwidth of the communication circuit. The method includes the following steps:
providing a body having a first surface and a second surface, where the first surface is provided with a through hole that runs through the first surface and the second surface;
forming, on the first surface, a first wire having a first endpoint, a second endpoint, and a specific shape, and electrically connecting the first endpoint to an external power supply; and
arranging a second wire in the through hole of the second endpoint, and electrically connecting the second endpoint to the communication circuit, so that the first wire and the communication circuit are coupled, and an oscillation frequency of the communication circuit is changed in a coupling biasing manner, thereby further achieving a purpose of adjusting the communication bandwidth.

In some embodiments, the communication circuit is one of a radio frequency circuit, a Bluetooth circuit, a GPS circuit, and a Wi-Fi circuit.

Based on the above, the present disclosure provides a coupling biasing device, in which the second wire is electrically connected to the communication circuit, and the oscillation frequency of the communication circuit is changed in a coupling biasing manner through the coupling effect between the first wire and the communication circuit, thereby further achieving the purpose of adjusting the communication bandwidth.

### BRIEF DESCRIPTION OF THE DRAWINGS

FIG. 1 is a schematic structural diagram of a conventional broadband biasing device.

FIG. 2 is a schematic structural diagram of a conventional tapered biasing device.

FIG. 3 is a schematic structural diagram of a coupling biasing device according to the present disclosure.

FIG. 4 is a schematic structural diagram of a first embodiment of a coupling biasing device according to the present disclosure.

FIG. 5 is a schematic structural diagram of a second embodiment of a coupling biasing device according to the present disclosure.

FIG. 6 is a schematic diagram showing steps of a power adjustment method for a communication circuit according to the present disclosure.

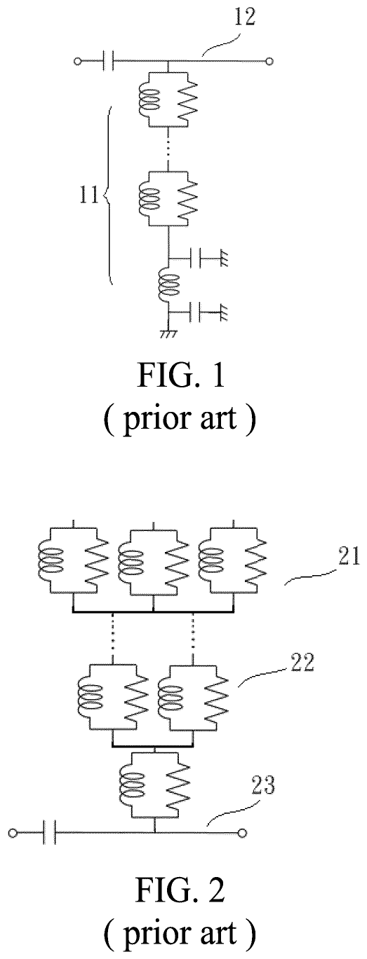

### DETAILED DESCRIPTION OF THE INVENTION

Implementations of the present disclosure are described below through specific embodiments. A person having ordinary skill in the art can understand other advantages and effects of the present disclosure from the content disclosed in this specification.

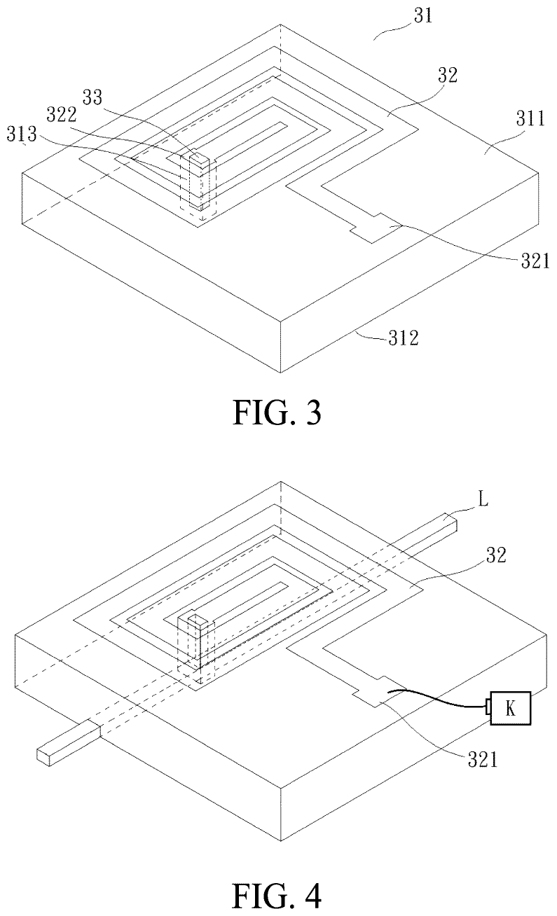

Refer to FIG. 3, which is a schematic structural diagram of a coupling biasing device according to the present disclosure. As shown in FIG. 3, the coupling biasing device is a biasing structure for a communication circuit. The coupling biasing device structure includes a body 31, a first wire 32, and a second wire 33. The body 31 is a plate made of one of silicon nitride, gallium nitride, or silicon carbide, and the body 31 has a first surface 311 and a second surface 312. The first surface 311 is provided with a through hole 313 that runs through the first surface 311 and the second surface 312. The first wire 32 is arranged on the first surface 311 in a winding manner having the specific shape of an octagon, a circle, or a square, and the first wire 32 has a first endpoint 321 and a second endpoint 322 arranged corresponding to the through hole 313. The second wire 33 is arranged in the through hole 313 corresponding to the second endpoint 322, and the second wire 33 is electrically connected to the second endpoint 322, where the first wire 32 and the second wire 33 are manufactured by a thin film process.

Refer to FIG. 4, which is a schematic structural diagram of a first embodiment of a coupling biasing device according to the present disclosure. As shown in FIG. 4, the coupling biasing device is arranged on one side of a communication circuit L, and is electrically connected to the communication circuit L through the second wire 33. During use, the first endpoint 321 is electrically connected to an external power supply K, so that the first wire 32 and the communication circuit L are coupled to change an oscillation frequency of the communication circuit L in a coupling biasing manner, thereby further achieving a purpose of adjusting a communication bandwidth.

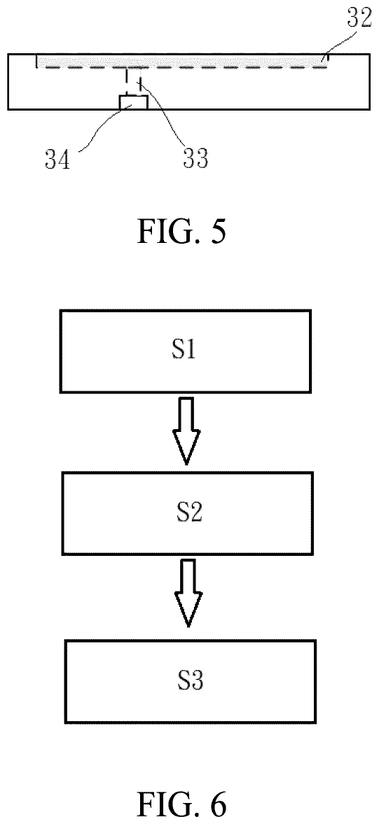

Refer to FIG. 5, which is a schematic structural diagram of a second embodiment of a coupling biasing device according to the present disclosure. As shown in FIG. 5, the second wire 33 is electrically connected to a conductive pad 34. The conductive pad 34 is electrically connected to a communication circuit (not shown in the figure). A distance between the second wire 33 and the conductive pad 34 is changed, so that coupling strength between the first wire 32 and the communication circuit changes correspondingly, so as to achieve an effect of adjusting and controlling the coupling, and change an oscillation frequency of the communication circuit in a coupling biasing manner, thereby further achieving a purpose of adjusting a communication bandwidth.

Refer to FIG. 6, which is a schematic diagram of a power adjustment method for a communication circuit according to the present disclosure, which is a method for adjusting a bandwidth of the communication circuit. The method includes the following steps.

Step 1 (S1): Provide a body 31, where the body 31 has a first surface 311 and a second surface 312, and the first surface 311 is provided with a through hole 313 that runs through the first surface 311 and the second surface 312.

Step 2 (S2): Form, on the first surface 311, a first wire 32 having a first endpoint 321, a second endpoint 322, and a specific shape, and electrically connect the first endpoint 321 to an external power supply K.

Step 3 (S3): Electrically connect a communication circuit L, arrange a second wire 33 in the through hole 313 of the second endpoint 322, and electrically connect the second endpoint 322 to the communication circuit L, so that the first wire 32 and the communication circuit L are coupled, and an oscillation frequency of the communication circuit L is changed in a coupling biasing manner, thereby further achieving a purpose of adjusting the communication bandwidth of the communication circuit L. In addition, the communication circuit L is one of a radio frequency circuit, a Bluetooth circuit, a GPS circuit, and a Wi-Fi circuit.

The foregoing embodiments are merely illustrative descriptions of the features and effects of the present disclosure, and are not intended to limit the scope of substantial technical content of the present disclosure. A person having ordinary skill in the art may modify and vary the foregoing embodiments without departing from the spirit and scope of the present disclosure. Therefore, the protection scope of the claims of the present disclosure shall be subject to the scope of the claims described below.

While the present disclosure has been described by means of specific embodiments, numerous modifications and variations could be made thereto by those skilled in the art without departing from the scope and spirit of the present disclosure set forth in the claims.

What is claimed is:

1. A coupling biasing device for use as a biasing device structure in a communication circuit, the coupling biasing device comprising:
a body, having a first surface and a second surface, wherein the first surface is provided with a through hole that runs through the first surface and the second surface;
a first wire, arranged on the first surface in a specific shape, wherein the first wire has a first endpoint and a second endpoint arranged corresponding to the through hole; and
a second wire, arranged in the through hole corresponding to the second endpoint, wherein the second wire is electrically connected to the communication circuit, and the first endpoint is electrically connected to an external power supply, so that the first wire and the communication circuit are coupled, and an oscillation frequency of the communication circuit is changed in a coupling biasing manner, thereby further achieving a purpose of adjusting a communication bandwidth of the communication circuit.

2. The coupling biasing device according to claim 1, wherein the body is a plate.

3. The coupling biasing device according to claim 1, wherein the body is made of one of silicon nitride, gallium nitride, or silicon carbide.

4. The coupling biasing device according to claim 1, wherein the first wire is arranged in a winding manner having the specific shape of an octagon, a circle, or a square.

5. The coupling biasing device according to claim 1, wherein the first wire and the second wire are manufactured by a thin film process.

6. A power adjustment method for a communication circuit, being a method for adjusting a communication bandwidth of the communication circuit, and the method comprising the following steps:
providing a body having a first surface and a second surface, wherein the first surface is provided with a through hole that runs through the first surface and the second surface;
forming, on the first surface, a first wire having a first endpoint, a second endpoint, and a specific shape, and electrically connecting the first endpoint to an external power supply; and
arranging a second wire in the through hole of the second endpoint, and electrically connecting the second endpoint to the communication circuit, so that the first wire and the communication circuit are coupled, and an oscillation frequency of the communication circuit is changed in a coupling biasing manner, thereby further achieving a purpose of adjusting the communication bandwidth.

7. The power adjustment method for a communication circuit according to claim 6, wherein the body is a plate.

8. The power adjustment method for a communication circuit according to claim 6, wherein the communication circuit is one of a radio frequency circuit, a Bluetooth circuit, a GPS circuit, and a Wi-Fi circuit.

9. The power adjustment method for a communication circuit according to claim 6, wherein the first wire is arranged in a winding manner having the specific shape of an octagon, a circle, or a square.

10. The power adjustment method for a communication circuit according to claim 6, wherein the first wire and the second wire are manufactured by a thin film process.
